(19) United States
(12) Patent Application Publication
(10) Pub. No.: US 2026/0138275 A1
(43) Pub. Date: May 21, 2026

(54) SYSTEM, METHOD, AND APPARATUS FOR INSPECTION ROBOT PATHING

(71) Applicant: Gecko Robotics, Inc., Pittsburgh, PA (US)

(72) Inventors: Jennifer Padgett, Baden, PA (US); Hannah Loy, Oakmont, PA (US); Aakash Rohra, Pittsburgh, PA (US)

(21) Appl. No.: 19/391,657

(22) Filed: Nov. 17, 2025

Related U.S. Application Data
(60) Provisional application No. 63/721,536, filed on Nov. 17, 2024.

(51) Int. Cl. B25J 9/16

(52) U.S. Cl. CPC B25J 9/1664; B25J 9/163

(57) ABSTRACT

A device may include an asset intelligence module configured to interpret a physical description of an asset for inspection. A device may include an inspection execution module configured to determine a pathing trajectory for an inspection robot in response to the physical description. A device may include a means for moving the inspection robot on the asset in response to the pathing trajectory.

### CROSS-REFERENCE TO RELATED APPLICATIONS

The present application claims the benefit of U.S. Provisional Patent Application No. 63/721,536, filed on 17 NOV 2024, and entitled “SYSTEM, METHOD, AND APPARATUS FOR INSPECTION ROBOT PATHING” (GROB-0018-P01). The foregoing application is incorporated by reference herein for all purposes.

### BACKGROUND

Inspection robots are increasingly utilized to provide inspection operations for various industrial facilities, in part to reduce costs of inspection, to improve inspection coverage for facilities, and to reduce exposure hazards for workers. While inspection robots in many circumstances provide for enhanced inspection coverage and reduced worker time commitment, inspection robot operations suffer from a number of challenges. Previously known inspection robots maneuver in response to remote control operations and/or simple instructions such as performing a number of passes over a surface to inspect an area. These maneuver operations result in coverage gaps, and in inefficiencies relative to travel distance, operating time, configuration changes of the inspection robot, and other operational complications.

### SUMMARY

Embodiments herein address some of the challenges in previously known systems, and without limitation reduce some of the drawbacks of using an inspection robot (e.g., compared to a manual inspection), enabling greater penetration in inspection markets, and further provide additional capabilities that are not available in previously known systems.

Example systems herein provide for inspection operations utilizing an inspection robot that improve inspection efficiency and result in improved inspection outcomes. Example systems herein can determine and implement pathing operations for the inspection robot that result in improved inspection coverage of an asset, reduced operating time for the inspection, improved inspection outcomes (e.g., ensuring coverage in difficult areas, supporting more complicated inspection regimes, reducing redundant travel and/or inspection operations, etc.), and/or reduced operational complexity for an operator of the inspection robot.

In some aspects, the techniques described herein relate to a system, including: an asset intelligence module configured to interpret a physical description of an asset for inspection; an inspection execution module configured to determine a pathing trajectory for an inspection robot in response to the physical description; and a means for moving the inspection robot on the asset in response to the pathing trajectory.

In some aspects, the techniques described herein relate to a system, further including: wherein the asset intelligence module is further configured to interpret at least one of the following asset associated values: an operation description; historical data; a feature description; external data; or an inspection description; and wherein the means for moving the inspection robot is further in response to the at least one of the asset associated values.

In some aspects, the techniques described herein relate to a system, further including: wherein the inspection execution module is further configured to determine a configuration trajectory for the inspection robot in response to the physical description; and a means for configuring the inspection robot on the asset in response to the configuration trajectory.

In some aspects, the techniques described herein relate to a system, wherein: the asset intelligence module is further configured to interpret at least one of the following asset associated values: an operation description; historical data; a feature description; external data; or an inspection description; and wherein the means for configuring the inspection robot is further in response to the at least one of the asset associated values.

In some aspects, the techniques described herein relate to a system, including: an asset intelligence module configured to interpret a physical description of an asset for inspection; an inspection execution module configured to determine a pathing trajectory for an inspection robot in response to the physical description; and the inspection robot having a movement controller responsive to the pathing trajectory, wherein the movement controller is configured to move the inspection robot on a surface of the asset.

In some aspects, the techniques described herein relate to a system, further including: wherein the asset intelligence module is further configured to interpret at least one of the following asset associated values: an operation description; historical data; a feature description; external data; or an inspection description; and wherein the movement controller is further responsive to the at least one of the asset associated values.

In some aspects, the techniques described herein relate to a system, wherein: the asset intelligence module is further configured to interpret at least one of the following asset associated values: an operation description; historical data; a feature description; external data; or an inspection description; and wherein the inspection robot further includes a configuration controller structured to perform a configuration operation in response to the configuration trajectory and the at least one of the asset associated values.

In some aspects, the techniques described herein relate to a system, further including: wherein the inspection execution module is further configured to determine a configuration trajectory for the inspection robot in response to the physical description; and wherein the inspection robot further includes a configuration controller structured to perform a configuration operation in response to the configuration trajectory.

In some aspects, the techniques described herein relate to a system, wherein the configuration operation includes at least one operation selected from: displaying an inspection description on at least one of a user device or the inspection robot; displaying a configuration indicator on at least one of a user device or the inspection robot; providing a confirmation interface on at least one of a user device or the inspection robot; or performing an automated configuration of at least one aspect of the inspection robot.

In some aspects, the techniques described herein relate to a method, including: interpreting a physical description of an asset for inspection; determining a pathing trajectory for an inspection robot in response to the physical description; and moving the inspection robot in response to the pathing trajectory.

In some aspects, the techniques described herein relate to a method, further including: interpreting an asset associated value; and moving the inspection robot further in response to the asset associated value.

In some aspects, the techniques described herein relate to a method, further including: interpreting an asset associated value; and determining the pathing trajectory further in response to the asset associated value.

In some aspects, the techniques described herein relate to a method, further including: determining a configuration trajectory for the inspection robot in response to the physical description; and configuring the inspection robot in response to the configuration trajectory.

In some aspects, the techniques described herein relate to a method, further including: interpreting an asset associated value; and configuring the inspection robot further in response to the asset associated value.

In some aspects, the techniques described herein relate to a method, further including: interpreting an asset associated value; and determining the configuration trajectory for the inspection robot further in response to the asset associated value.

### BRIEF DESCRIPTION OF THE FIGURES

FIG. 1 depicts an example system for inspection robot pathing.

FIG. 2 depicts example aspects of an inspection execution module.

FIG. 3 depicts example aspects of an asset intelligence module.

FIG. 4 depicts additional or alternative example aspects of an asset intelligence module.

FIG. 5 schematically depicts an example pathing trajectory and configuration trajectory.

FIG. 6 depicts example features of interest on an inspection surface of an asset.

FIG. 7 depicts an example group of facilities and an operator location package.

FIG. 8 depicts an example operator location package at a facility.

FIG. 9 schematically depicts an example procedure to move an inspection robot in response to a pathing trajectory.

FIG. 10 schematically depicts an example procedure to move and/or configure an inspection robot in response to a pathing trajectory and/or configuration trajectory.

### DETAILED DESCRIPTION

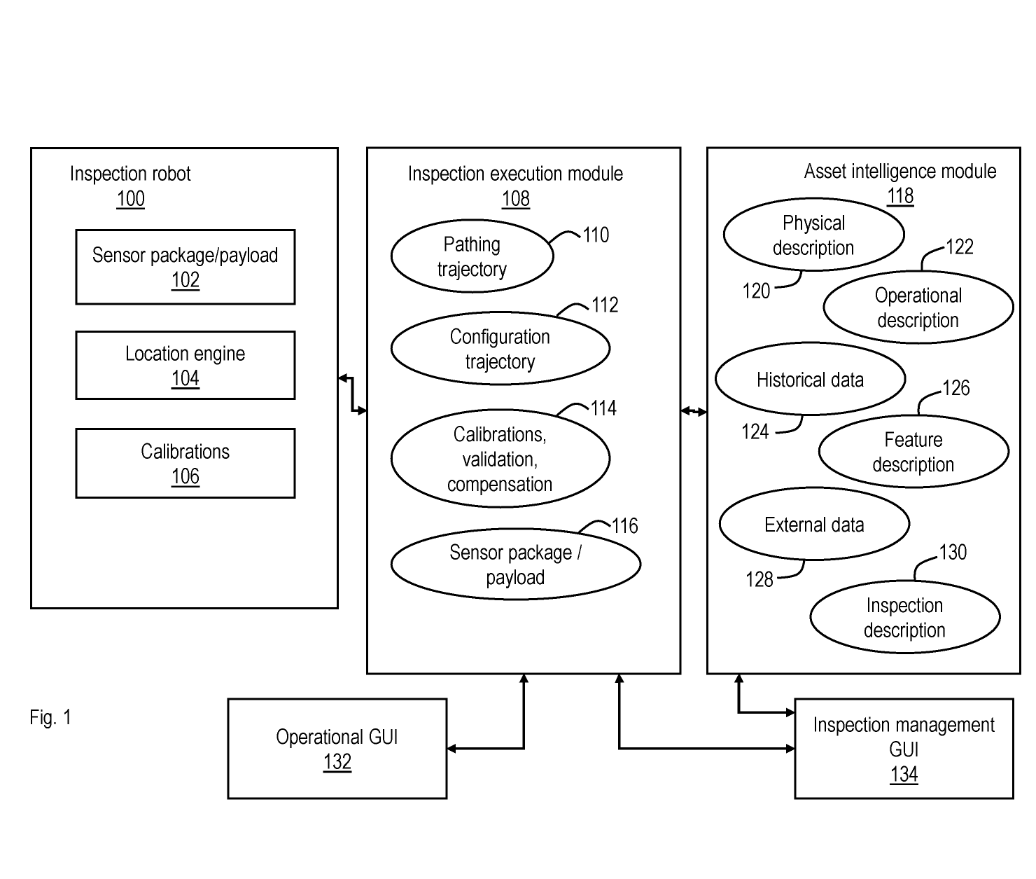

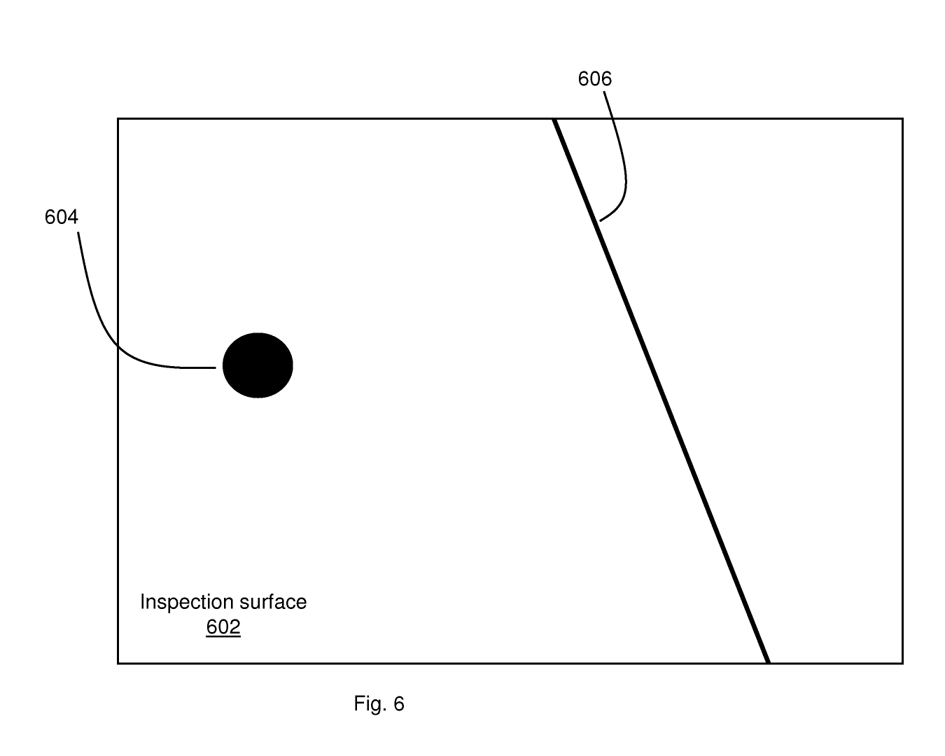

Referencing FIG. 1, an example system includes an inspection robot 100 having a number of aspects configured to allow the inspection robot 100 to traverse an inspection surface 602 (e.g., reference FIG. 6), thereby placing sensors into operational communication with the surface, and allowing planned inspection operations to be performed. The inspection robot 100 may attach to and move along the surface utilizing any mechanism, for example the inspection robot may utilize magnetic wheels or magnetic tracks to allow the inspection robot to traverse the surface vertically. However, the inspection robot may be fixed to the surface and moved along the surface utilizing any mechanism, including utilizing the weight of the inspection robot to fix to the surface (e.g., the inspection robot placed on an approximately flat horizontal surface), using attachment mechanisms based on fluid (e.g., air) pressure (e.g., suction cups), and/or using attachment mechanisms based on van der Waals forces. In certain embodiments, for example where the inspection robot 100 follows a determined pathing on the inspection surface operating with automated motion, motion control actuators are present and operated by a controller on the inspection robot 100 that provides movement commands in response to the determined pathing.

The example inspection robot 100 includes a sensor package and/or payload 102, for example the hardware configuration of sensors on the inspection robot, including coupling of the sensors to the inspection robot, and positioning the sensors in a configuration that is operably coupled to the inspection surface at the desired locations. In certain embodiments, a payload is a conceptual framework for a modular component that can mount a sensor or group of sensors to an inspection robot in a position utilizable for inspection operations. An example payload includes a number of similar sensors distributed horizontally (e.g., across the direction of travel for the inspection robot) in a manner allowing for an inspection movement of the inspection robot 100 to perform inspection operations on several lanes simultaneously. Another example payload includes a sensor that is moved horizontally (e.g., using a rastering device) to provide the selected horizontal position of the sensor during inspection operations, for example with the rastering device moving the sensor back and forth, with either continuous and/or stepwise forward (e.g., vertical) motion of the inspection robot 100. In certain embodiments, more than one sensor may be combined with a rastering device – for example to allow multiple inspection operations at each location, and/or to allow for more rapid horizontal coverage (e.g., using more than one rastering device).

It can be seen that a greater number of sensors on a payload allows for improved inspection resolution (e.g., reducing the average distance between inspected points, or any similar metric providing an indication of inspection density on the inspection surface and/or a region thereof), improved inspection speed (e.g., providing a greater inspected area per unit of movement of the inspection robot), inspection using multiple sensor types in a single run, and/or enhanced inspection redundancy (e.g., allowing for compensation and/or off-nominal operation response due to overlap of some inspected areas by more than one sensor). It can be seen that a reduced number of sensors on a payload reduces the complexity of inspection operations, including configuring the inspection robot, performing inspection operations, and validating the inspection data in real time. The number of such sensors may be according to any configuration, and may be limited according to constraints such as payload weight, power requirements, couplant delivery requirements, data collection rate limitations, data processing and/or validation limitations, or the like. In certain embodiments, selection of pathing operations for the inspection robot, including strategic and/or tactical pathing, and/or including the consideration of inspecting multiple assets, can affect the cost/benefit considerations for payload configurations, for example including the number and/or distribution of sensors on the payload. Accordingly, embodiments herein include determining the inspection robot configuration (e.g., and/or a sequence of configurations as a configuration trajectory 112) in response to a pathing trajectory 110, determining a pathing trajectory 110 in response to an inspection robot configuration, and/or determining the pathing trajectory 110 and the inspection robot configuration together in response to another cost (e.g., inspection operation time, utilization of capital assets, etc.) and/or benefit (e.g., inspection coverage and/or quality) parameter. One of skill in the art, having the benefit of the disclosure herein, can readily determine the configuration of the inspection robot, including mounting sensors and/or payloads thereon, the selection of sensors, the positioning of the sensors, and the coverage paradigm for inspection operations as the inspection robot traverses the inspection surface. Without limitation to any other aspect of the present disclosure, example and non-limiting considerations for determining the pathing trajectory and/or inspection robot configuration include: inspection time operational costs; costs of inspection operations (e.g., utilization of power, consuming the wear life of significant components, cost of activities incurring risks performed as a part of inspection operations); facility cost of inspection operations (e.g., disruption, set up impact, inspection operation impact, shutdown costs); time horizons of interest (e.g., value at 5 years, net present value, ongoing continuous value, etc.); and/or facility information (e.g., life span of the facility, upcoming changes or volatility to production, maintenance schedules, etc.).

The example inspection robot includes a location engine 104. The example location engine 104 performs operations on the inspection robot to determine and utilize the position of the inspection robot on the inspection surface, to determine the location of features on the inspection surface, to determine position information associated with inspection data, and/or to perform operations responsive to the pathing trajectory 110 and/or configuration trajectory 112 – for example ensuring that the inspection robot follows the scheduled path, and utilizes the correct sensors and processing operations at the correct locations on the inspection surface. The location engine 104 may utilize any location determination operations and/or hardware, including for example: encoders, accelerometers, gyros, cameras, radar, Lidar, utilization of WiFi or other signals, or the like. The location engine 104 may determine position, orientation, velocity, acceleration, awareness of actuator positions (e.g., payloads raised or lowered, current downforce on the payload, and/or any other determinations associated with the location of the inspection robot, for example determining weight distribution and lift off parameters for the inspection robot. In certain embodiments, the location engine 104 may be embodied as a computing device communicatively coupled to the implementing hardware and/or the inspection execution module 108. In certain embodiments, the computing device may include a controller on the inspection robot. The location engine 104 may be a single device and/or may be a distributed device, for example with portions distributed on a controller of the inspection robot, on an external controller (e.g., on an operator station and/or a cloud server), and/or with portions embodied in hardware such as an encoders, accelerometers, gyros, cameras, radar, Lidar system, and/or any component of such systems.

The example inspection robot 100 includes calibrations 106, which may be on a controller of the inspection robot and/or in a location communicatively available to the controller of the inspection robot. The calibrations 106 include any parameters utilized to perform inspection operations, including parameters utilized to operate sensors (e.g., impulse commands, time cutoffs, A/D processing values, diagnostic values, etc.) and/or otherwise perform inspection operations. For example, certain parameters such as a couplant flow rate, speed limitations, payload downforce limitations, or the like, may be indicated by the inclusion of a particular payload 102, but are not directly a part of the payload 102 (e.g., to operate sensors and/or actuators properly). In certain embodiments, a calibration 106 includes any parameter that is utilized to ensure proper operation of a payload 102 and that may be configurable to ease tuning the utilization of the payload for the particular inspection operations being contemplated. In certain embodiments, utilizing calibrations 106 to tune the utilization of a payload 102 on an inspection robot 100 allows for rapid and confident utilization of different payloads 102, and/or differences in utilization of a particular payload 102, which consequently provides additional parameters to improve and/or optimize determination of pathing and/or configuration trajectory(ies) 110, 112 for the inspection robot for an inspection operation and/or for a selected group of inspection operations. For example, a pathing trajectory 110 that provides slow, high resolution inspection operations in a first area of interest (e.g., a high sensitivity area), and rapid, low resolution inspection operations in a second area of interest (e.g., a low sensitivity area) may utilize different calibrations 106 for performing inspection operations in each area of interest, optionally utilizing the same sensing hardware in each area of interest.

The example system includes an inspection execution module 108 configured to perform certain operations to determine pathing, configurations, calibrations, or the like for inspection operations, and/or to implement commands with the inspection robot and/or implement an operational GUI to assist in inspection operations. The inspection execution module 108 is depicted as a single computing device in the example of FIG. 1, but the inspection execution module 108 and/or aspects thereof may be distributed across a number of computing devices and/or other hardware components such as sensors, actuators, display devices, network communication devices, or the like. In certain embodiments, the inspection execution module 108 is embodied, at least in part, on one or more computing devices such as: a controller of the inspection robot, a computing device associated with an operator (e.g., a laptop or mobile device accessible to the operator), a cloud server computing device, and/or a facility computing device (e.g., a computer and/or server positioned at a facility having an asset to be inspected). The example inspection execution module 108 determines aspects of inspection operations, and/or provides commands and/or other communications to the inspection robot, to an operational GUI 132 (e.g., accessible to an operator for the inspection operation), to an inspection management GUI 134 (e.g., accessible to a stakeholder for the inspection operation, such as a facility manager, operations supervisor, data analyst, etc.), and/or to an asset intelligence module 118, in response to the determined aspects of inspection operations. Example and non-limiting determined aspects for inspection operations include one or more of: a pathing trajectory 110 (e.g., the positions of the inspection robot during inspection operations, including movement between the positions); a configuration trajectory 112 (e.g., the configuration of the inspection robot over the parametric identifier for the trajectory); processing aspects 114 for the inspection operation such as calibrations, validation operations, and/or compensation operations; and/or a sensor package 116 (and/or payload). In certain embodiments, the sensor package/payload 116 may have directly controllable aspects, for example where multiple sensors are provided on a payload, and sensor selection is performed by enabling or disabling some of the sensors, and/or by configuring data collection operations from a selected subset of the sensors. In certain embodiments, the sensor package/payload 116 is confirmable (e.g., according to communications from a sensor, the actual installed sensor can be confirmed) by the inspection execution module 108, but not directly controllable (e.g., the inspection execution module identifies an incorrect sensor installed, but does not physically change the sensor). In certain embodiments, the status of the sensor package/payload 116 may be displayed on the operational GUI 132 and/or the inspection management GUI 134, provided in any reports, and/or may be associated with collected inspection data allowing for later validation or confirmation of the settings and hardware configuration utilized for the relevant inspection operations.

A trajectory, as utilized herein, includes values for the operating parameter of the trajectory (e.g., the pathing, the configuration, etc.) corresponding to values for a parametric identifier (e.g., time). The parametric identifier may include any type of parameterizing value, including at least time, inspection operation stage, any sequenced value such as position, or the like. In certain embodiments, more than one parameterizing value may be utilized, and/or parameterizing values may be normalized and/or built into an index which may be weighted. An example trajectory includes a sequence of operations to be followed over time, to be executed in a sequence, to be executed at a particular stage of the inspection operations, or the like. In certain embodiments, different trajectories may utilize different parametric identifiers, for example a pathing trajectory may use time and/or position to sequence movement, and a configuration trajectory may use inspection operating stage to sequence inspection robot configurations during the inspection operations. In certain embodiments, a trajectory may be mixed, for example where a pathing trajectory utilizes position sequencing to move during a segment of the inspection operations, and utilizes inspection operation stages to sequence moving between areas of interest for inspection operations on an inspection surface.

The inspection execution module 108 supports inspection operations by providing commands directly to the inspection robot 100, implementing an operational GUI 132, and/or implementing an inspection management GUI 134. In certain embodiments, the inspection execution module 108 communicates with the inspection robot 100 to provide direct communication commands (e.g., communicating a position target, a movement sequence to be executed, and/or providing direct actuator commands to drive motors on the inspection robot), to set and/or confirm calibrations, proper hardware configuration, determine diagnostic status values, or the like. In certain embodiments, the inspection execution module 108 provides the pathing trajectory 110 and/or configuration trajectory 112 (e.g., as one or more schedules) to the operational GUI 132. The trajectories 110, 112 may be utilized by the operator to track progression (e.g., with a current state of the inspection robot depicted on the schedule), to adjust the trajectories (e.g., before inspection operations, and/or to make adjustments to the plan in real-time), and/or to provide a guide for the operator to follow (e.g., where the operator may move the inspection robot using remote commands, at least during some operating conditions, and/or may manually adjust inspection operations following a trajectory 110, 112, such as manually re-positioning the inspection robot, changing a payload, changing a computing board of the inspection robot, etc.).

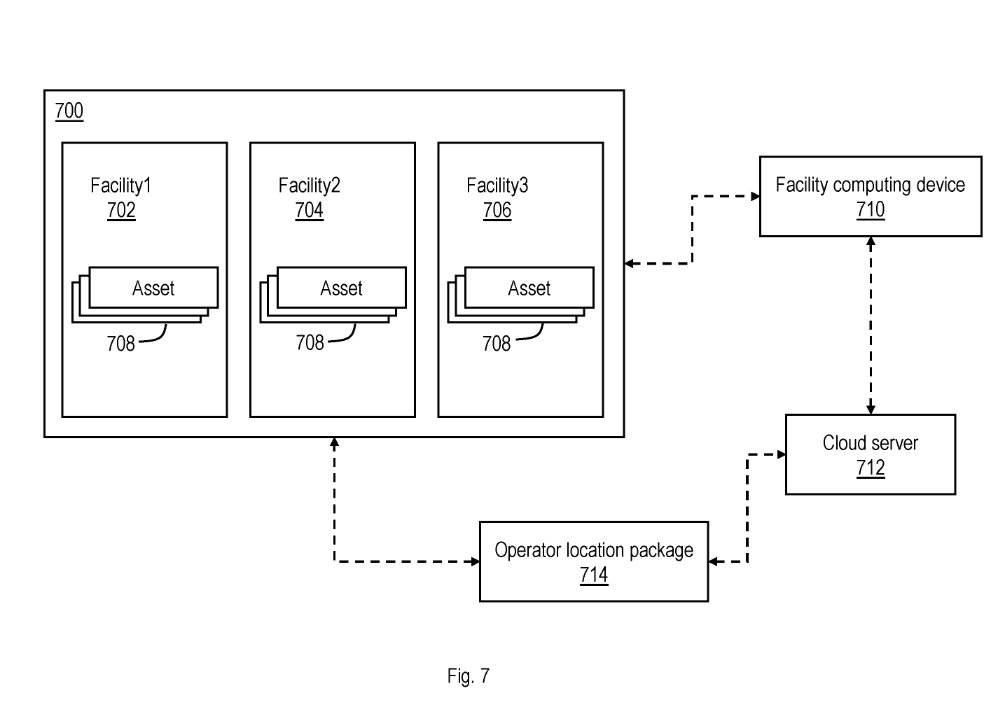

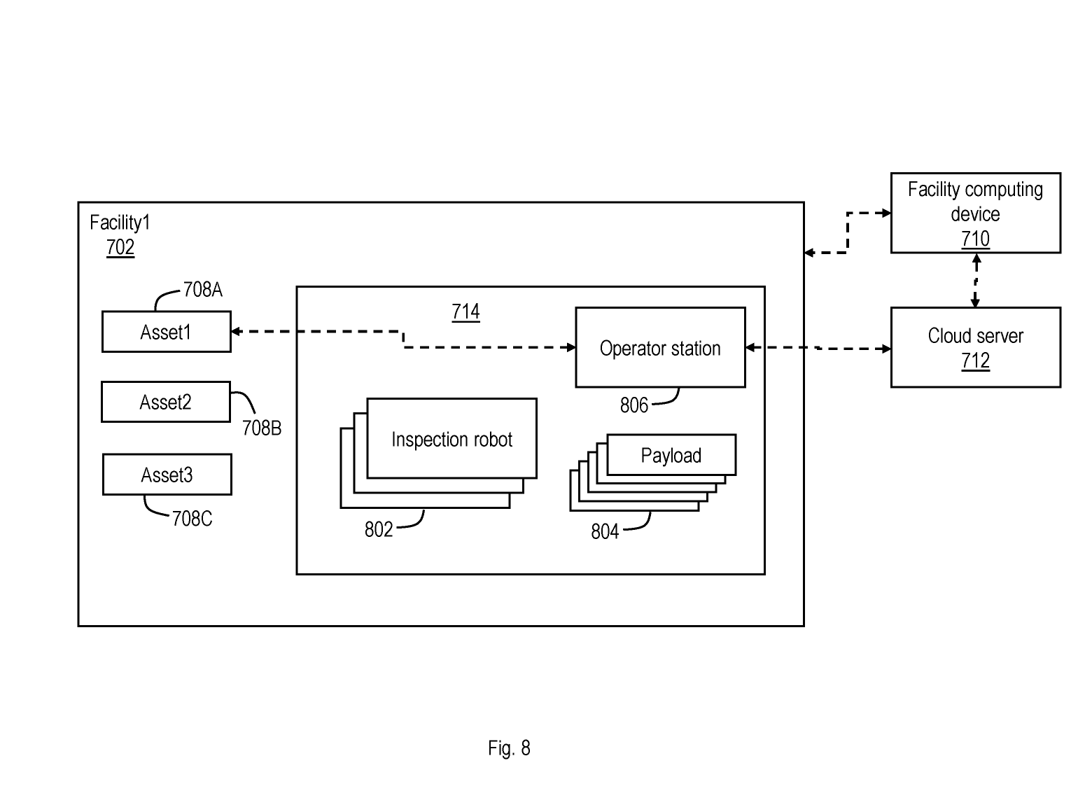

The example system includes an asset intelligence module 118 configured to perform certain operations to provide information relevant to determining the pathing and/or configuration trajectory of the inspection robot(s) 100 to perform inspection operations, and to make that information available to the inspection execution module 108 at the relevant time (e.g., design time for an inspection operation, set-up time before the inspection operation, either at location or in a dispatch shop, and during run-time operations of the inspection robot). The asset intelligence module 118 is depicted as a single computing device in the example of FIG. 1, but the asset intelligence module 118 and/or aspects thereof may be distributed across a number of computing devices and/or other hardware components such as sensors, actuators, display devices, network communication devices, or the like. In certain embodiments, the asset intelligence module 118 is embodied, at least in part, on one or more computing devices such as: a cloud server computing device 712 (e.g., reference FIG. 7), a computing device associated with an operator (e.g., a laptop or mobile device accessible to the operator, such as operator station 806 (reference FIG. 8)), a facility computing device 710 (e.g., a computer and/or server positioned at a facility having an asset to be inspected), and/or a controller of the inspection robot (e.g., a controller embodying at least a portion of the location engine 104, and/or on a distinct controller (not shown)).

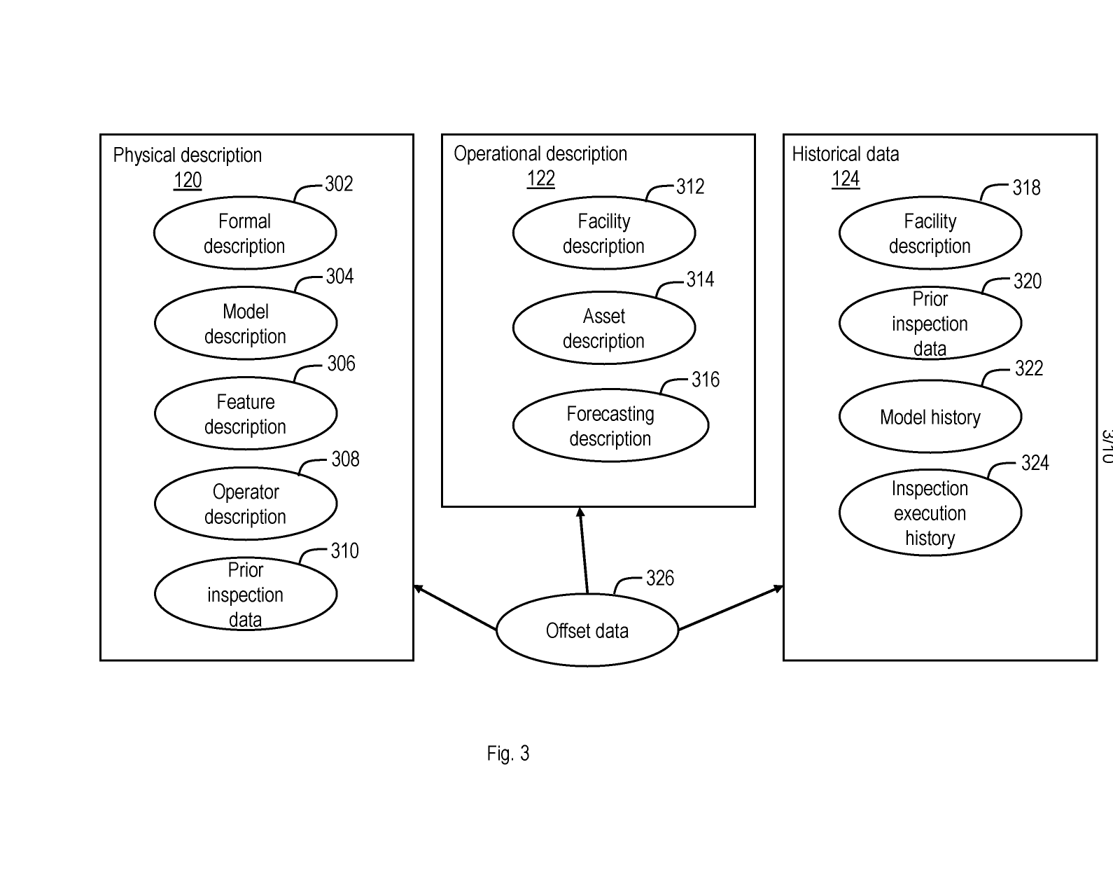

An example asset intelligence module 118 determines a physical description 120 of an asset for inspection, including for example the geometry of the asset and resulting inspection surface, regions of the inspection surface that should be inspected and/or which characteristics are being inspected, the position on the inspection surface of features of interest (e.g., obstacles, previously damaged areas, areas of interest for high resolution inspection and/or for certain types of inspection, etc.), etc. Referencing FIG. 3, example and non-limiting aspects of the physical description 120 include one or ore aspects such as: a formal description 302 (e.g., CAD drawings, manufacturer drawings, geometric approximations, etc.) of the asset; a model description 304 (e.g., a near-net mathematical approximation, any model of an aspect of the asset that might change inspection results, such as a temperature model, coating thickness model for acoustic response, etc.) related to the asset; a feature description 306 of the asset (e.g., provided based on an initial description, such as from a manufacturer detail of the asset, entered by the operator, determined during inspection operations, and/or determined from previous inspection operations on the asset and/or an offset asset); an operator description 308 (e.g., allowing the operator to make any notes during an inspection operation, and for those notes to be immediately available on the operational GUI 132 and/or inspection management GUI 134 for planning operations during design time, and/or performing operations during run time); and/or prior inspection data 310 (e.g., utilized to ensure coverage, to track coverage statistics over time, to group similar areas on the asset for more efficient inspection operations, etc.).

The example asset intelligence module 118 determines an operational description 122, which may include operational information about the asset that is potentially relevant to inspection operations, for example operating temperatures, pressures, utilization time, shutdown procedures (if any) relevant to inspection operations, effects of inspection operations on the facility having the inspected asset, etc. The operational description 122, where utilized, allows the system to account for operational risks to the facility that may depend upon inspection outcomes and/or execution, such as the cost of downtimes, the likelihood, location, orientation, and/or severity of expected corrosion, cracking, fouling, or other aspects that may be the target of inspection determinations, and/or that may inform which aspects should be inspected or how they should be inspected (e.g., damage orientation and/or depth may indicate different sensors, sensor settings, and/or robot movement parameters). Referencing FIG. 3, an example operational description includes a facility description 312, an asset description 314, and/or a forecasting description 316 (e.g., allowing for determination of inspection operation parameters in response to upcoming changes in operating conditions for the facility, effects of equipment wear, servicing, and replacement over time, etc.). In certain embodiments, any aspect of the operational description may be determined, additionally or alternatively, in response to offset data 326 (e.g., data relating to other facilities and/or inspected assets having relevant similarity in at least one aspect to the facility and/or asset related to determining the pathing trajectory 110 and/or the configuration trajectory 112). The utilization of the operational description 122 allows for planning considerations to include aspects such as, and without limitation: the cost of inspection operations, special operational considerations or constraints for inspection operations due to operating parameters of the facility, execution time for inspection operations on the target asset and/or within the target facility, and/or coordination of multiple inspection operations for a facility (e.g., inspecting multiple assets, and/or performing multiple inspection types on asset(s)) while minimizing operational impact to the facility.

The example asset intelligence module 118 determines historical data 124 relevant to planned inspection operations, including historical inspection data, operational data, model performance data, and/or inspection execution data (e.g., notations of any operational anomalies, special conditions at the location, identified features, etc. from prior inspections, a facility sight check, notes from a facility operator, etc.). Referencing FIG. 3, example and non-limiting historical data 124 includes: a facility description 318 (e.g., any historical data associated with a facility including a target asset, and/or a facility that is in a related group of facilities to the facility including the target asset), prior inspection data 320, model history data 322 (e.g., models of the asset shape and/or geometry, models of asset wear and/or damage, and/or models related to inspection operations such as success rates and/or completion times), and/or inspection execution history data 324 (e.g., success rates, completion times, and/or other inspection execution data or outcomes based on previous and/or offset inspection executions). The historical data 124 may relate to the target asset, a target facility, a related group of facilities, and/or offset data 326 (e.g., an offset asset, facility, and/or group of facilities).

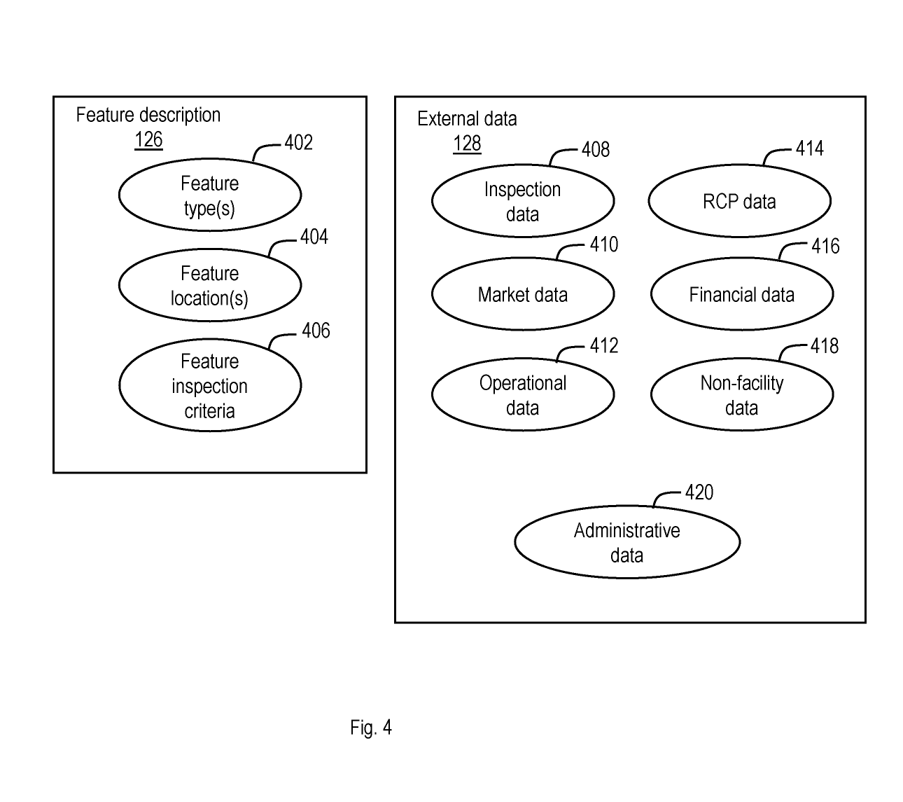

The example asset intelligence module 118 determines a feature description 126, which may include a feature type 402 (reference FIG. 4) (e.g., “obstacle”, “weld line”, “thickness anomaly”, etc.), a feature location 404 (e.g., a location including a selected coordinate system, and which may include a range or asset-fencing description, and/or multiple ranges), and/or a feature inspection criteria 406 (e.g., a description of inspection criteria, such as sensing type, sensing parameters, sensing resolution (spacing of data locations) and/or sensing resolution (precision of data), etc. In certain embodiments, multiple ranges may be defined in a feature location, for example a feature location may include a weld line location, a heat-treated region location (e.g., within a specified distance from the weld line, such as within 6-12 inches), and a far field region (e.g., a further distance from the weld line, such as out to 24 inches) for enhanced inspection that is not expected to show effects from the weld line (e.g., for confirmation, to ensure the area of interest is fully bounded, etc.). In certain embodiments, each region may be utilized for data tagging (e.g., to ensure the relevant data can be readily queried and analyzed), to enforce any relevant inspection operations (e.g., limiting movement speed, adjusting sensing parameters such as sampling rate, inducement energy, processing parameters, etc.), to stitch together and coordinate inspection regions into a full asset inspection display, or the like. The utilization of a feature description 126 provides a framework to perform various operations such as: leverage inspection execution efficiency supporting operations; communicate interesting aspects of the asset between the operator (e.g., using the operational GUI 132), an interested customer or facility operator (e.g., using the inspection management GUI 134 and/or a computing device associated with the facility and at least selectively in communication with the inspection execution module 108 and/or asset intelligence module 118), and a separate data/inspection analyst (e.g., using the inspection management GUI 134); and/or to allow for implementation of lessons learned between operators performing inspection operations on an asset or within a group of related assets, including allowing applicable lessons learned to be implemented automatically.

The example asset intelligence module 118 determines external data 128 to support operations to determine a pathing trajectory 110 and/or a configuration trajectory 112 for inspection operations of an asset, a group of assets at a facility, and/or a group of assets distributed across a number of facilities. Referencing FIG. 4, example and non-limiting external data 128 includes aspects such as: inspection data 408 (e.g., data collected for the asset and/or an offset asset outside of the system, for example by a different inspection robot and/or inspection service provider); market data 410 (e.g., demand data for a production output of the facility, including short or long term data, for example to inform wear estimates, future utilization estimates, shutdown costs, etc.); operational data 412 (e.g., operational data for the asset and/or facility that may be utilized for any reason, such as to estimate wear or utilization, cost of down time operations, consequences of an asset failure, etc.); data relating to regulations, certifications, and/or policies (“RCP data” 414), which may be utilized to ensure inspection operations will achieve the goals, operational requirements (e.g., work time allowance, proximity to hazards, etc.) are met during planned inspection operations, appropriate data is both collected and stored during inspection operations (e.g., for appropriate reporting); financial data 416 related to the asset (e.g., utilized to determine capital expenditure vs. operating costs, including enforcing the trade-offs between these that best meet the facility business goals; to determine inspection costs; and/or to estimate the cost of an asset failure and/or replacement); non-facility data 418 (e.g., any data that may affect the final inspection plan but exists outside of the facility, such as calendar date/holiday events, weather events, traffic events, news events (e.g., news related to the facility, an entity associated with the facility, a related industry, etc.), and/or social media events; and/or administrative data 420 (e.g., facility work schedules, work time limitations for workers, scheduling limitations for inspection operations at the facility, facility shutdown/slowdown criteria and constraints, etc.). In certain embodiments, external data 128 that is relevant may be surfaced over time, for example by a machine learning component that discovers relevant external data 128 that has predictive value for an aspect of the facility. Accordingly, the external data 128 utilized by a system may change over time, and/or may be distinct when determining a pathing trajectory 110 and/or configuration trajectory 112 for different assets, and/or for the same asset at different times. The external data 128 may be any data that can be accessed by the asset intelligence module 118, at least intermittently and/or selectively, and that may potentially improve operations to determine a pathing trajectory 110 and/or a configuration trajectory 112 for inspection operations on at least some assets.

The example asset intelligence module 118 determines an inspection description 130, which may be utilized to capture any inspection operation learning that occurs during inspection operations. For example, selection of downforce for a payload, limitations on maximum movement speed or acceleration, utilization of particular sled configurations, couplant flow rates, shutdown times and/or operations performed between stages of inspection operations, etc. The inspection description is utilized to leverage any on-site learning that is apparent to the inspection operator that may not surface in analysis of the data – for example due to conditions of the inspection surface (e.g., texture, moisture, dirt on the surface, etc.), complications in executing the inspection on-site (e.g., part of the site is inaccessible every 20 minutes to allow a forklift to pass through, the stairs obstacle is loose and moves several inches back and forth unlike what is identified in the data, etc.). The inspection description 130 may come from previous inspection operations at the location, analysis of any available data before a site visit (e.g., descriptions of the facility, pictures of the location, discussion with a facility operator, etc.), and/or based on inspection operations data that exists for any offset asset or facility.

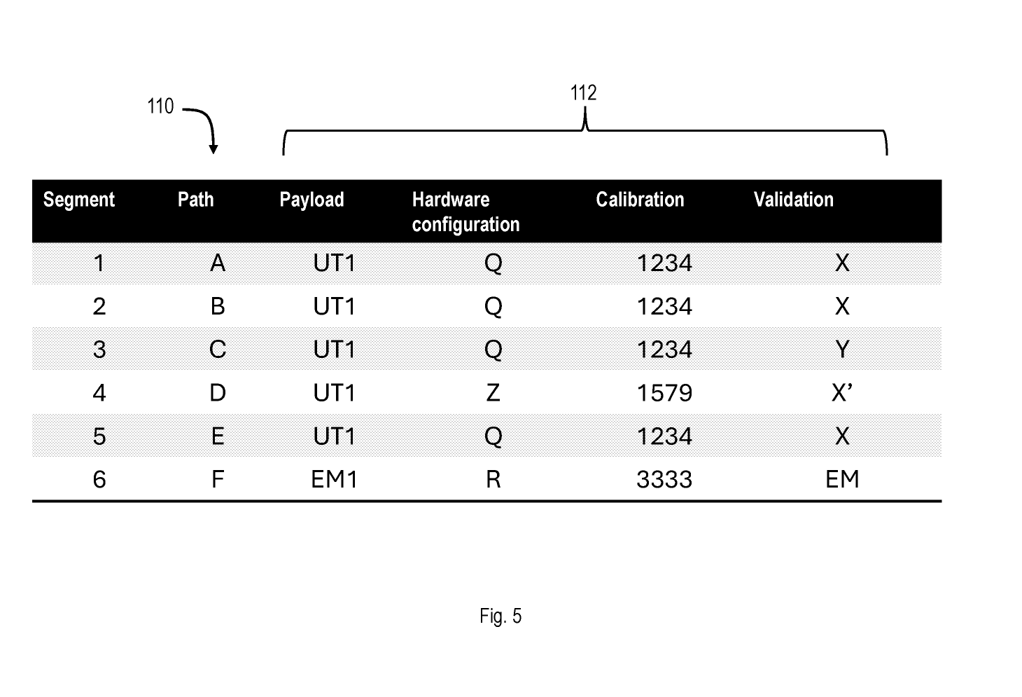

Referencing FIG. 5, an example pathing trajectory 110 is schematically depicted, and is included in a combined table that also depicts the configuration trajectory 112. In the example of FIG. 5, the parametric identifier is a job segment (e.g., segment 1-6), where each segment is completed, potentially in order, to complete the inspection operations. In the example of FIG. 5, the example trajectory includes a path description (e.g., where and how the inspection robot will travel during the related segment), a payload description (e.g., the hardware payload configuration to be utilized for the segment), a hardware configuration (e.g., how the actuators will be positioned, spacing and downforce on sensors, rastering speed and extent, etc.), a calibration description (e.g., which calibration settings and/or processing algorithms are to be utilized), and/or a validation description (e.g., which validation algorithms and/or workflows are to be utilized to validate the inspection data). The example of FIG. 5 depicts the trajectory schematically. In the example of FIG. 5, one section of the asset (covered by path “F”) is being inspected utilizing payload “EM1” (e.g., an electromagnetic based sensor, such as an EMI sensor), which utilizes a distinct hardware configuration, calibrations, and validation operations, relative to the other sections. In the example of FIG. 5, the other sections of the asset are inspected by an ultrasonic sensor payload “UT1”, operating in a first manner over pathing sections A-C and E, and operating in a second manner over pathing section D. The first manner, in the example, includes hardware configuration Q, calibration 1234, and validation operation X. The second manner, in the example, includes hardware configuration Z, calibration 1579, and validation operation X’. The utilization of a trajectory for pathing and/or configuration, such as depicted in FIG. 5, allows for a scheduled inspection operation that continuously improves and/or optimizes inspection outcomes and the efficiency of inspection operations (e.g., maximizing the positive inspection outcome indicia achieved per unit of inspection operation cost). In the example of FIG. 5, the trajectory 110, 112 would be consistent with performing a higher resolution inspection in the region near a feature of interest (defined by path D), and performing all UT inspection operations before switching to EMI inspection operations. Overall, the trajectory for pathing and/or configuration can be utilized to reduce any cost in the system, to improve any outcome in the system, and/or to improve the relationship between any cost and/or outcome. Accordingly, embodiments herein may include, without limitation, a system that: reduces the cost of inspection operations (e.g., inspection time, wear increment on the inspection robot or a component thereof, reduced facility shutdown time, etc.); reduces a negative aspect of the cost of inspection operations (e.g., avoiding a high consequence negative cost event, even if the total or average cost is increased); improves a benefit of the inspection operations (e.g., improved resolution, improved or simplified compliance, improved wear model performance, improved shutdown/failure prediction, improved match of an estimate or prediction to actual performance, etc.); and/or changes the cost/benefit relationship in a beneficial manner (e.g., reduced cost, improved benefit, improved cost/benefit difference and/or ratio, etc.).

Referencing FIG. 6, an example inspection surface is schematically depicted, with two features of interest (604 and 606). In the example, feature 606 is a weld line, which may be utilized to enhance position determinations of the inspection robot (e.g., by comparing current position with the weld line), and which may further be utilized to determine a pathing and/or configuration trajectory for inspection operations using one or more inspection robots. In certain embodiments, the pathing trajectory includes moving the inspection robot over the inspection surface to cover a region of interest around the weld line 606, which may include specifically moving the inspection robot through the region of interest with the appropriate sensing capability turned on (e.g., a trilateral UT sensor package, a time of flight sensor, a camera based visual inspection sensor, etc.). In another example, the pathing trajectory includes moving the inspection robot over the surface, and ensuring that whenever the inspection robot is operating within the region of interest for the weld line 606, the appropriate sensing configuration, calibrations, and/or validation operations are utilized. Stated differently – a region of interest can be inspected explicitly by dedicating a pathing operation to cover that region, or implicitly, by ensuring that inspection operations within that region are properly performed as the inspection robot passes through. In certain embodiments, where configuration operations require a hardware change – for example changing a physical sensor or sensor sled, the pathing trajectory will likely include a dedicated segment of the pathing for such a region. In certain embodiments, where configuration operations can be performed automatically and/or remotely while the inspection robot is on the inspection surface, then the region of interest can be inspected in any manner that improves the overall inspection outcome, which may include switching the configuration of the inspection robot as it traverses through different regions, having multiple sensor payloads that can be utilized alternatively (or simultaneously), and/or nevertheless utilizing a dedicated pathing segment for the region of interest for other reasons (e.g., to ensure seamless location data through the region, to reduce operational complexity, to reduce switching operating logic of the inspection robot, etc.). In the example of FIG. 6, the feature 604 is a different feature, such as an obstacle and/or an anomalous data reading location, where the pathing determination accounts for the feature 604 appropriately, for example scheduling pathing operations to get inspection data as close to feature 604 as possible, to ensure the anomalous data reading is tracked, etc.

Referencing FIG. 7, an example system includes an operator location package 714 (e.g., a computing device, inspection robot(s), configuration options for the robot(s) such as sled surface options, payload options, DAQ/board options, peripheral options, drive module options, etc.), where the operator location package 714 provides the operational GUI 132 to the operator (e.g., utilizing a display and input interfaces of device(s) accessible to the operator, such as a mobile device, laptop, base station computer, etc.), allowing the operator to rapidly configure and confirm the inspection robot, and to confirm and follow the pathing trajectory 110 and/or configuration trajectory 112 for the inspection robot(s) during inspection operations. In certain embodiments, the pathing and/or configuration trajectories include the number of inspection robots as a design parameter, for example allowing more than one inspection robot to coordinate inspection operations, including accounting for the physical position of the inspection robots to ensure that inspection operations, data collection, tether lines, EMI emissions, and the like between robots do not interfere. In certain embodiments, operations to determine the pathing and/or configuration trajectories can account for the operational cost and complexity of operating more than one inspection robot, the number of assets at a facility that will be inspected (e.g., multiple robots inspecting 40 tanks is more likely to be efficient than multiple robots inspecting a single tank), and the like. In the example of FIG. 7, a cloud server provides support for the operator, including for example housing the asset intelligence module, the inspection execution module, and/or portions thereof. The example of FIG. 7 further includes a facility computing device 710, for example accessible by a facility operator, owner, manager, compliance officer, or the like, and which may have a customer relevant version of an inspection management GUI 134. In the example of FIG. 7, a number of facilities 702, 704, 706 are in a group 700 of facilities, for example a number of facilities to be inspected, and each having a number of assets 708 positioned thereat.

Referencing FIG. 8, a schematic detail version of the operator location package 714 is depicted. In the example of FIG. 8, an operator station 806 (e.g., computing device, couplant support, power support, etc.) communicates with an inspection robot 802 on an inspected asset, to the cloud server 712 and supporting applications thereon, and/or to the facility computing device 710. The example of FIG. 8 schematically depicts the operator location package 714 at a facility 702, for example during inspection operations, for example during an inspection of an asset at the facility 702 (e.g., asset1 708A, in the example of FIG. 8). Other assets are depicted at the facility (e.g., Asset2708B, and asset3708C) for illustration. In the example of FIG. 8, the operator location package 714 includes a number of inspection robots (e.g., for redundancy and/or additional capabilities, such as inspection robots with distinct data acquisition capabilities, surface traversal capabilities, surface coupling mechanisms, payload weight capabilities, etc.). The example of FIG. 8 schematically depicts a number of payloads 804, which may be available for redundancy, to replace consumable or maintenance parts, payloads with distinct sensor mountings to allow for different inspection operations, payloads with cleaning and/or repair components, or the like. In certain embodiments, the operator location package 714 may include additional sensors or sleds, computing boards for the inspection robot, and/or any other hardware components that would be useful to the operator at the inspection location.

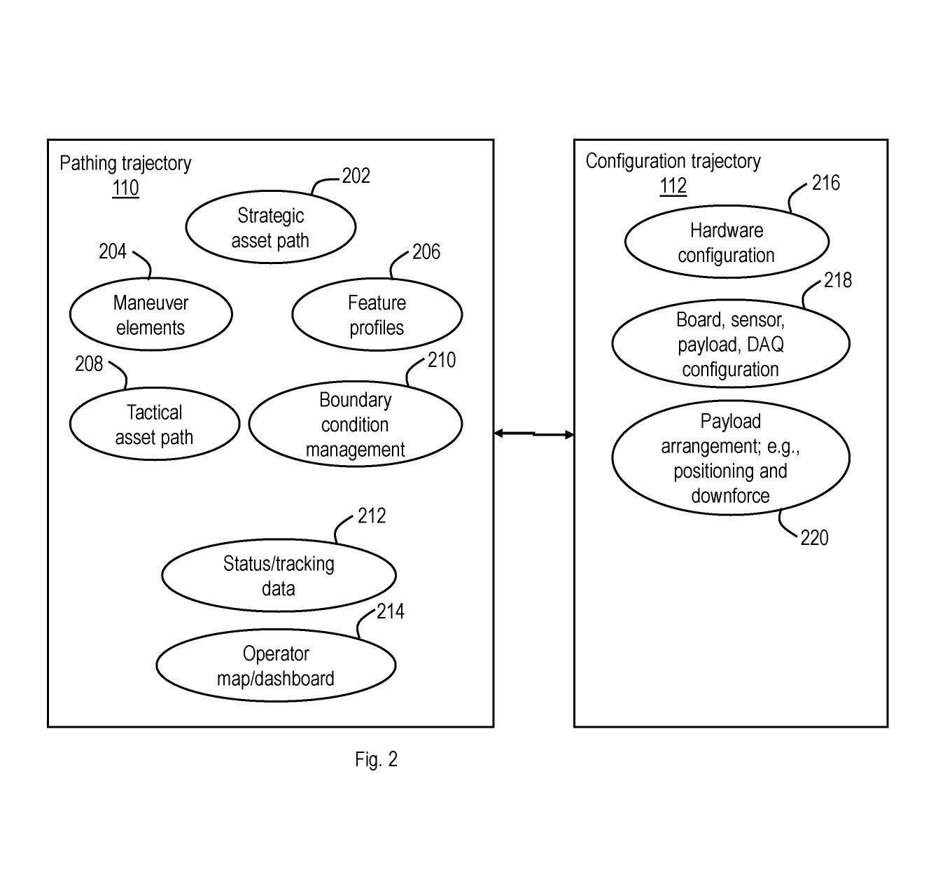

Referencing FIG. 2, an example pathing trajectory 110 is schematically depicted. In a given embodiment, any one or more, or all, of the pathing trajectory aspects of the example of FIG. 2 may be included, including having different elements of the pathing trajectory at different times and/or different operating conditions. The example pathing trajectory 110 includes a strategic asset path 202 – for example a description of the regions of the asset that are to be inspected, which may be separated from the actual path or sequencing to perform the inspection operations. The strategic asset path 202 may be utilized to ensure that inspection operations are completed, to survey the entire area for potential features, obstacles, or challenges to inspection operations, and/or to define contiguous areas on the inspection surface utilized to minimize the number of configuration changes or manage other operational aspects of the inspection operations. The example pathing trajectory 110 includes maneuver elements 204, which may be a more tactical description of movement operations for the inspection robot, for example to define movement sequences that may be utilized multiple times to perform typical movement operations. For example, a maneuver element 204 may include a specific maneuver (e.g., operations to turn around 180⁰, to move over 18 inches to the left facing in the same orientation, operations to inspect vertically to the extent of the asset and return to a specific offset location for the next run, etc.), a specific pathing section (e.g., covering a rectangle, L-shape, or other geometric sequence that can be logically tiled to cover the target inspection surface), or the like. The maneuver elements allow for intermediate packaging of movement instructions between low level movement (e.g., provide 12 V to the front left motor) and top level guidance (e.g., inspect region A), and create a framework to simplify the steps of commanding the movement for either a remote controlled operator system or a fully automated movement system.

The example pathing trajectory 110 includes feature profiles 206 for each feature on the inspection surface, noting that during inspection operations additional features may be added. The feature profiles 206 allow for enhancement of inspection operations near features of interest, provide a framework for relative and absolute positioning of data on the inspection surface, allow for pathing operations to consider challenge-related features (e.g., obstacles, corroded regions, areas where contact with the inspection robot may be suspect due to corrosion, debris, or loss of metal within the surface, etc.) in the full context of inspections for a facility and ensure that interest-related features receive the full planned inspection service. The example pathing trajectory 110 includes a tactical asset path 208, which may be a segment of the strategic asset path 202, a specific sequencing of movement for a portion of the strategic asset path 202, or the like. In certain embodiments, the tactical asset path 208 may include one or more maneuver elements, and/or may be embodied as one of the maneuver elements. In certain embodiments, the tactical asset path 208 may be changed according to observed conditions and results, for example determining to repeat a section where the data did not validate, where the strategic asset path 202 is typically a coverage goal that is not changed (but it may be, for example if it is determined that a planned area for inspection is physically not available for inspection, and/or where inspection information in one area indicates that the strategic asset path 202 should be changed – for example adding, modifying, or removing planned inspection operations).

The example pathing trajectory 110 includes a boundary condition management 210, for example a set of conditions that are utilized to keep the inspection robot operational and able to continue its mission. For example, the boundary condition management 210 may include a velocity limit, acceleration limit, orientation limits, a line-of-sight constraint (e.g., a number of features, where pathing of the inspection robot should be within line-of-sight of one, or “n”, number of features, and/or time/distance out of line-of-sight should be minimized, etc.), considerations for the tether (e.g., don’t cross tethers with multiple inspection robots, don’t pass over a feature that will interfere with the tether, do not exceed a vertical limit for the tether, etc.), control of downforce on the payload (e.g., to ensure contact, but prevent lift-off of the inspection robot from the surface). The boundary condition management 210 is utilized to keep the inspection robot in a safe condition and capable to complete inspection operations, and most parameters that relate to the motion of the inspection robot and/or positioning thereof are potential boundary conditions for management, and in certain embodiments time derivative values thereof are often utilized to predict the approach of a boundary condition before it is exceeded.

The example pathing trajectory 110 includes a status/tracking data 212 for the pathing trajectory, for example allowing an operator display 132 for the current progress of inspection operations, allowing the operator to adjust the pathing trajectory 110 and/or run scenarios therefore, and/or to guide the operator where at least a portion of the pathing trajectory 110 is followed by a remote operator and/or where the operator may be overriding the pathing trajectory 110 (e.g., to allow the operator to resume operations according to the pathing trajectory 110 when ready). In certain embodiments, the status/tracking data 212, and/or any other data throughout the present disclosure, may be provided on an operator map or dashboard 214 (e.g., displayed at least in part on the operational GUI 132), and/or to any other interested party, such as a facility operator and/or analyst (e.g., through the inspection management GUI).

Further referencing FIG. 2, example and non-limiting aspects of a configuration trajectory 112 are schematically depicted. The example configuration trajectory 112 includes a hardware configuration 216, for example indicating which payloads, sensors, computing boards, wheel and/or surface engagement features, or the like are to be installed on the inspection robot for inspection operations. The example configuration trajectory 112 includes an electronic configuration 218, for example determining which boards, sensors, payloads, and/or data acquisition devices are present, and ensuring they can inter-communicate properly, and have the selected settings for actuation (e.g., sensor excitation and/or sampling algorithms, etc.), data collection rates, sequencing of operations, and the like. The example electronic configuration 218 may include a listing of parameters, and/or may include operating modes (e.g., high rate ultra-sonic testing for surface depth of 0.3 inches), where the operator can readily confirm that the operating modes and/or parameter values are properly set, and/or adjusted during inspection operations, according to the configuration trajectory 112. The example configuration trajectory 112 includes a payload arrangement 220, for example describing the appropriate positioning and/or content of each payload, and/or settings for the payload such as applied downforce, horizontal position, or the like. In certain embodiments, the payload can be modified automatically, for example using an actuator to adjust a horizontal position of a payload and/or the applied down force on the payload, with the operator able to confirm and/or adjust the values using the operational GUI 132.

A number of procedures are described following. Operations depicted may be performed by any hardware, controller, engine, computing device, module, and/or any other component as set forth throughout the present disclosure.

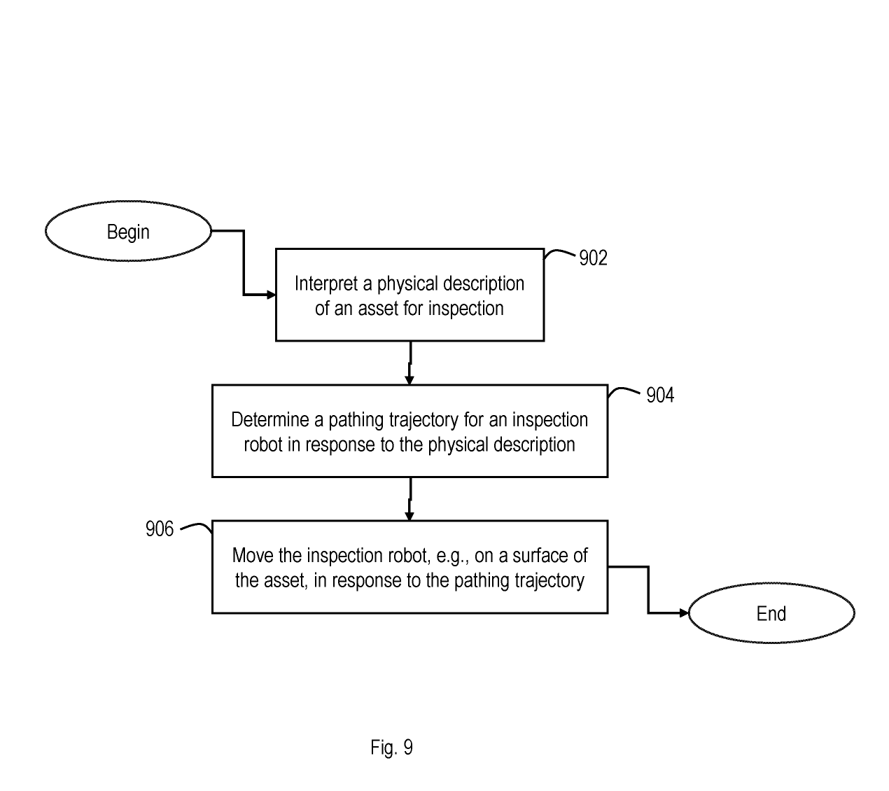

Referencing FIG. 9, an example procedure includes an operation 902 to interpret a physical description of an asset for inspection, and an operation 904 to determine a pathing trajectory for an inspection robot in response to the physical description. The example procedure includes an operation 906 to move the inspection robot on a surface of that asset in response to the pathing trajectory.

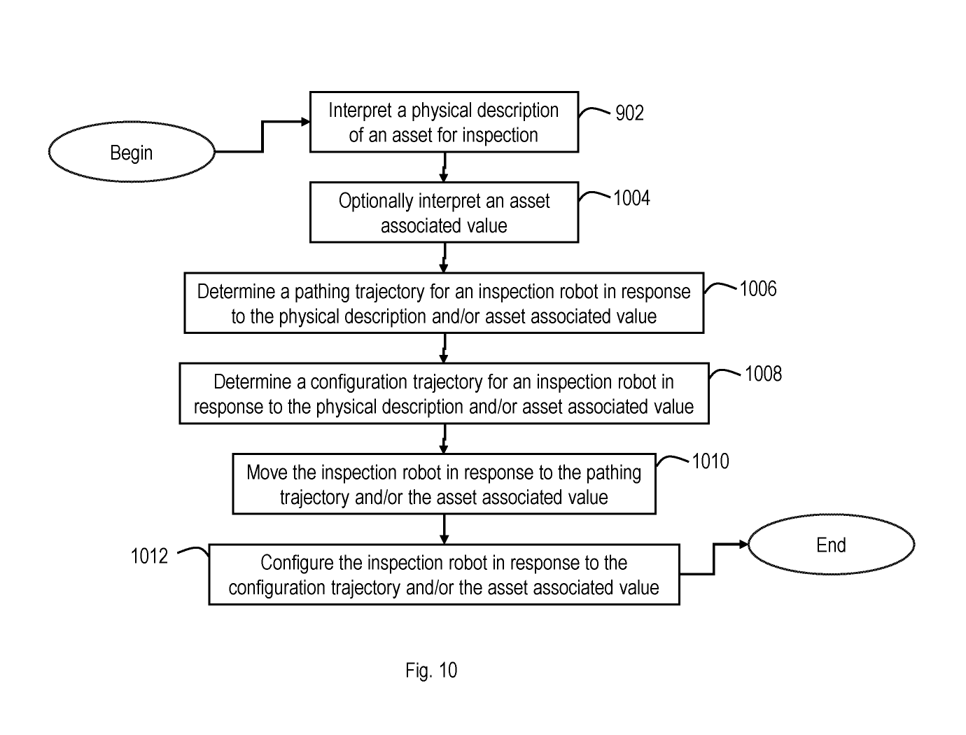

Referencing FIG. 10, an example procedure includes the operation 902, and an optional operation 1004 to interpret an asset associated value. The procedure includes an operation 1006 to determine a pathing trajectory for an inspection robot in response to the physical description, and/or further in response to the asset associated value. The procedure includes an operation 1008 to determine a configuration trajectory for the inspection robot, which may be determined in response to the physical description and/or the asset associated value. The example procedure 1010 includes an operation to move the inspection robot in response to the pathing trajectory, and/or further in response to the asset associated value (e.g., allowing the inspection robot to adjust movement from the pathing trajectory, for example to respond to asset conditions indicated by the asset associated value). The example procedure 1012 includes an operation to configure the inspection robot in response to the configuration trajectory, and/or further in response to the asset associated value (e.g., allowing the inspection robot to adjust the configuration from the configuration trajectory, for example to respond to asset conditions indicated by the asset associated value).

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, module, engine, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A system, comprising:
an asset intelligence module configured to interpret a physical description of an asset for inspection;
an inspection execution module configured to determine a pathing trajectory for an inspection robot in response to the physical description; and
a means for moving the inspection robot on the asset in response to the pathing trajectory.

2. The system of claim 1, further comprising:
wherein the asset intelligence module is further configured to interpret at least one of the following asset associated values: an operation description; historical data; a feature description; external data; or an inspection description; and
wherein the means for moving the inspection robot is further in response to the at least one of the asset associated values.

3. The system of claim 1, further comprising:
wherein the inspection execution module is further configured to determine a configuration trajectory for the inspection robot in response to the physical description; and
a means for configuring the inspection robot on the asset in response to the configuration trajectory.

4. The system of claim 3, wherein:
the asset intelligence module is further configured to interpret at least one of the following asset associated values: an operation description; historical data; a feature description; external data; or an inspection description; and
wherein the means for configuring the inspection robot is further in response to the at least one of the asset associated values.

5. A system, comprising:
an asset intelligence module configured to interpret a physical description of an asset for inspection;
an inspection execution module configured to determine a pathing trajectory for an inspection robot in response to the physical description; and
the inspection robot having a movement controller responsive to the pathing trajectory, wherein the movement controller is configured to move the inspection robot on a surface of the asset.

6. The system of claim 5, further comprising:
wherein the asset intelligence module is further configured to interpret at least one of the following asset associated values: an operation description; historical data; a feature description; external data; or an inspection description; and
wherein the movement controller is further responsive to the at least one of the asset associated values.

7. The system of claim 6, wherein:
the asset intelligence module is further configured to interpret at least one of the following asset associated values: an operation description; historical data; a feature description; external data; or an inspection description; and
wherein the inspection robot further includes a configuration controller structured to perform a configuration operation in response to the configuration trajectory and the at least one of the asset associated values.

8. The system of claim 5, further comprising:
wherein the inspection execution module is further configured to determine a configuration trajectory for the inspection robot in response to the physical description; and
wherein the inspection robot further includes a configuration controller structured to perform a configuration operation in response to the configuration trajectory.

9. The system of claim 7, wherein the configuration operation comprises at least one operation selected from:
displaying an inspection description on at least one of a user device or the inspection robot;
displaying a configuration indicator on at least one of a user device or the inspection robot;
providing a confirmation interface on at least one of a user device or the inspection robot; or
performing an automated configuration of at least one aspect of the inspection robot.

10. A method, comprising:
interpreting a physical description of an asset for inspection;
determining a pathing trajectory for an inspection robot in response to the physical description; and
moving the inspection robot in response to the pathing trajectory.

11. The method of claim 10, further comprising:
interpreting an asset associated value; and
moving the inspection robot further in response to the asset associated value.

12. The method of claim 10, further comprising:
interpreting an asset associated value; and
determining the pathing trajectory further in response to the asset associated value.

13. The method of claim 10, further comprising:
determining a configuration trajectory for the inspection robot in response to the physical description; and
configuring the inspection robot in response to the configuration trajectory.

14. The method of claim 13, further comprising:
interpreting an asset associated value; and
configuring the inspection robot further in response to the asset associated value.

15. The method of claim 13, further comprising:
interpreting an asset associated value; and
determining the configuration trajectory for the inspection robot further in response to the asset associated value.
